(19) United States
(12) Patent Application Publication
(10) Pub. No.: US 2012/0054728 A1
(43) Pub. Date: Mar. 1, 2012

(54) MAINTAINING A DATABASE OF PATCH DATA

(76) Inventors: Scott Rohde, Sunnyvale, CA (US); Michael L. Saboff, San Jose, CA (US); Peter Lyons, Louisville, CO (US); Harleen Serai, Union City, CA (US)

(21) Appl. No.: 12/872,245

(22) Filed: Aug. 31, 2010

(51) Int. Cl. G06F 9/44

(52) U.S. Cl. 717/168

(57) ABSTRACT

Methods of maintaining a database of patch data for a system include parsing differences between a posted update and a previously posted update, prioritizing patch data from the posted update and a plurality of additional sources, and supplementing patch data in the database for the posted update based on parsed differences and the plurality of additional sources.

### BACKGROUND

Modern computer systems have various software running thereon that contain very large amounts of software code. The code provides a framework for how a computer system performs its day to day operations, including interaction with application software, hardware, firmware, users, and the like. Large, complex programs, such as operating systems (OS), office productivity programs, graphics programs, and the like may require frequent updates to fix problems, especially relating to security, or otherwise integrate new or changed software, hardware, and the like. To update a program, typically the manufacturer of the program releases a variety of patches. For example, OS code includes routines and modules for nearly every aspect of the operation of a computer system, and can be extremely complex.

Because not every patch is useful for each particular installation of a program, and because patches can sometimes fix one problem and create another, patch management has become important, especially for large organizations. Patch management uses a strategy and plan of what patches should be applied to which systems at a specified time, and depends in part on evaluation of the patch and how it may affect not only that portion of the program that is being patched, but other parts of the program, and in the case of an OS, other programs that are on the computer system.

Software providers typically provide a file containing a number of patches in one file, or providers may provide individual patches. Patches may require additional programs or modules to be installed, or other prerequisites to be present in the system or program before the patch can be installed. In some instances, a file indicating the changes contained in the patch, along with their prerequisites and other requirements, is included with the patch. Because the code for an OS is so complex, certain patches or parts of patches may obsolete old patches, may break old patches, or may cause other issues with the OS.

The files indicating what a patch contains and the various requirements such as prerequisites is often contained in a metadata file. To determine what patches to install, it is important to have information about the patches. For example, before a patch can be installed, prerequisites to the patch may have to be installed. Many providers provide a file with metadata that contains that prerequisite type of information. However, in many instances, the information contained in a metadata file provided by the software provider is incomplete, or even inaccurate, and therefore does not contain all information necessary for a complete patch solution. Companies with large numbers of computers operating across multiple locations and the like prefer to know that the patch they are installing is going to be compatible with the computer systems and network they are operating, so as to avoid potential issues relating to downtime and loss of productivity.

For various types of information contained in patches, and specifically the metadata file provided with the patch, there are different degrees of overall accuracy for the data. That is, the general reliability and inclusion of information varies depending on what the information is, and primary references such as the patch itself and a metadata file provided by the software provider do not provide a complete set of information.

For the above reasons, and for other reasons stated below which will become apparent to those skilled in the art upon reading and understanding the present specification, there is a need in the art for a way to provide complete patch data.

### BRIEF DESCRIPTION OF THE DRAWINGS

FIG. 1 is a flow chart diagram of a method according to one embodiment of the present disclosure;

FIG. 2 is a flow chart diagram of a method according to another embodiment of the present disclosure;

FIG. 3 is a flow chart diagram of a method according to another embodiment of the present disclosure;

FIG. 4 is a flow chart diagram of a method according to another embodiment of the present disclosure;

FIG. 5 is a flow chart diagram of a method according to another embodiment of the present disclosure;

FIG. 6 is a flow chart diagram of a method according to another embodiment of the present disclosure; and

FIG. 7 is a block diagram of a computer system on which embodiments of the present disclosure are practiced.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, electrical, or mechanical changes may be made without departing from the scope of the present disclosure. The following detailed description is, therefore, not to be taken in a limiting sense, and the scope of the present disclosure is defined by the appended claims and equivalents thereof.

The various embodiments include methods of providing complete patch data for a program such as an operating system, as well as methods of maintaining a database of patch data current for patch updates. The various methods allow construction of a complete and correct database of patch information and proper patch updates by obtaining the complete database using multiple sources. The sources include in one embodiment the actual patch file, metadata reference files associated with the patch file, files included with the patch file, third party sources, and customer- or user-supplied source material. For example, a customer or user can create its own source of input data, e.g. an XML supplement file. The user data can be used as another data source that can be reconciled into the final database.

The various methods synthesize a complete database for a patch, beginning with a primary source, and adding information from secondary sources. The various methods also construct a new supplemental data source to add additional data whenever correctness cannot be established from other data sources. In order to build a database of patch information that is correct for the patch, and includes all the information that is to be used to make a complete and working patch,

Because complex software, and especially operating systems, have patches that are typically produced in multiple numbers nearly every day, management of patches can become very time consuming. As has been mentioned, patches that are applied without some knowledge of exactly what the patch fixes, as well as what it might not be compatible with, may cause additional problems with previous patches. While such problems are typically fixed later with another patch, the associated down time and lost productivity can make bad patches very costly. Typical metadata files for patches of operating systems may be replacement patches for old patches, or may mark a previous patch as bad or obsolete. Further, patch data may disappear from one patch to another as the patches update and change. Patches can also offer fixes for a number of issues all at once, when perhaps only one or a few of the actual fixes are desired by a customer. Some customers do not wish to or do not have the time to update with every patch. Further, large customers sometimes wait for a patch to be installed and tested by others in the industry before it is installed on the customer's systems. This allows bugs and problems with the patch to be corrected or at least identified.

The various examples of the present disclosure track changes from patch version to patch version, so that as each new patch is released, the primary and secondary sources are utilized to create a change file that includes a complete patch data database allowing an update from any version of a patch to any other version of a patch. As software providers update and change patches, often a change that has been made in a previous version of a patch will be deleted from the current patch file, and information that may be present in one patch may not necessarily be present in a subsequent patch. However, if a customer wishes to make the changes of an obsolete patch, for any reason, they cannot do so with the current patch system, as the changes that are made to patch data are typically cumulative.

For example, in an OS environment, typically when a patch becomes obsolete, the provider deletes the entry for that patch from the metadata file. Once the patch is deleted, it is very difficult to go back and find it again, and even more difficult to install or determine conflicts between that patch and current patches or other programs. Just because a patch has become obsolete also does not mean that it is a bad patch. Instead, another later patch may make all the changes the original patch would have made, plus additional changes. Those additional changes may not be desired by a customer, or may be untested to the point that a customer does not trust that the patch is suitable for installation at the given time. Using only the patch itself as well as a metadata file provided with the patch would result in an inability to patch using any obsolete patch, even if that patch were desired by the customer.

In the various embodiments of the present disclosure, information on obsolete patches, even if they are not currently available in the latest patch from a software provider, are available for any version. This is accomplished in one embodiment by creating a database with a change file that retains information on patches even if they are declared obsolete by a provider. A subsequent patch may fix multiple bugs, only one of which is desired by the customer, or institute a newer fix that could be a bad fix.

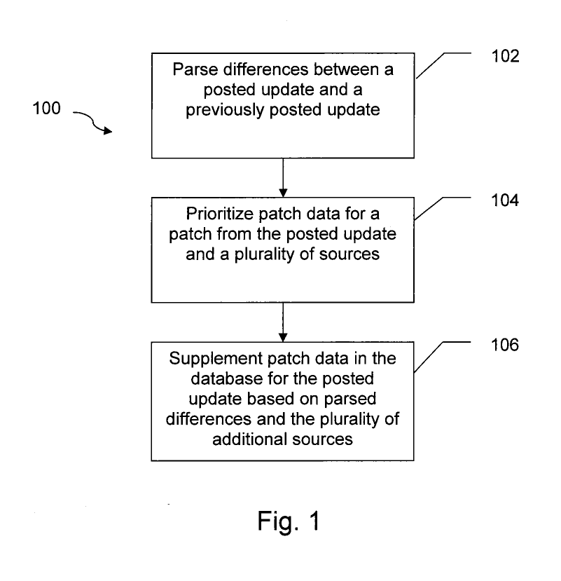

In one example, a method 100 of maintaining a database of patch data for a system is shown in FIG. 1. Method 100 comprises parsing differences between a posted update and a previously posted update in block 102, prioritizing patch data for a patch from the posted update and a plurality of sources in block 104, and supplementing patch data in the database for the posted update based on parsed differences and the plurality of additional sources in block 106. In another example, the database is only updated for those portions that have changes. In this example, the database update file contains only those portions of the database that have changes. Further, because the changes are what is presented in the database of patch data, and the update of the database does not require hard coding of solutions into a software tool the changes that are provided in a database update may provide changes to a plurality of revisions of a program such as an operating system via a single line in a patch database. Still further, supplementing patch data may be performed for all program revisions regardless of patch data when applicable.

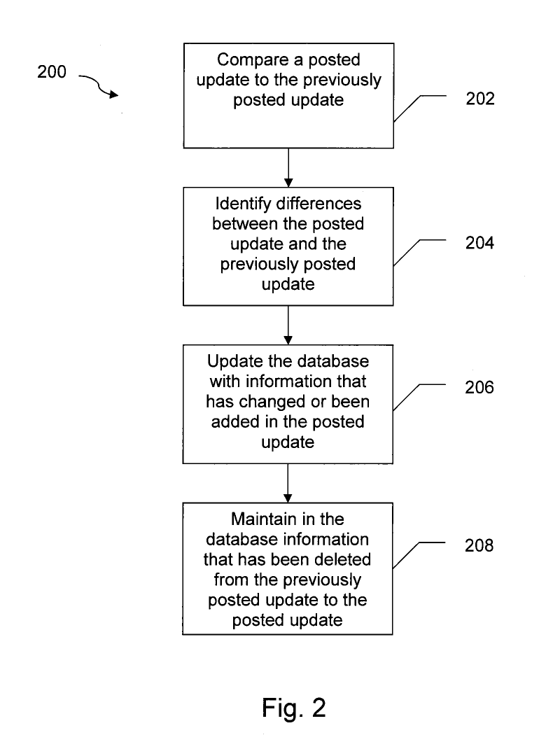

Differential parsing operates in various embodiments as shown in greater detail in FIG. 2. In one example, parsing 200 includes comparing a posted update to the previously posted update in block 202, identifying differences between the posted update and the previously posted update in block 204, updating the database with information that has changed or been added in the posted update in block 206, and maintaining in the database information that has been deleted from the previously posted update to the posted update in block 208.

The differential parsing of the various embodiments operates with respect to a specific piece of software as follows. An example describing the differential parsing of an operating system patch is described, but it should be understood that the present examples are amenable to use with software patching for any number of different pieces of software. When a patch is provided from the software provider, and includes a metadata file, the entire metadata file is parsed to create an initial data set for that patch. The changes between the initial data set and a previous patch database are determined through the differential parsing processes described above, and the differences between the files are processed.

There are three general types of changes in files, added lines, deleted lines, and changed lines. Deleted lines result in storing the information that was deleted in case it is later needed. New lines are added. Changed lines are treated according to the change. For each change noted in the parsing, a union of the old and new database portions, or a prioritized change is made to the metadata. The parsing of all changes, the union of data or use of prioritized data, and the accumulation of change data as well as new and deleted data, allows a customer to have at its disposal a database containing data about how to apply or remove a patch from any pervious version of the software to the current version.

For an operating system patching metadata file, a typical size of the file can be 20000 lines, and the amount of lines that actually change on any given day is typically on the order of 10-20 lines a day. If a change file is used, even after a month, only 500-600 lines of code are changed, and a change file can be much shorter than the 20000 lines of a metadata file. Using a change file saves time both for processing our patch metadata database. In one embodiment, if a customer has downloaded a patch, the information in the patch is parsed and new or more accurate metadata is added to the metadata database. The first source of information is the metadata file, which contains information about all currently released patches. The metadata file in one example discloses the existence of a patch. In that instance, if a customer indicates interest in the patch, it can be downloaded for determination of any supplementing or correction to make the patch more reliable.

An advantage to keeping and maintaining a change file as the database is that only those patches that a customer has installed and that also have changes are worked with. That is, if a patch is not installed by a customer, or that patch does not have any changes in the updated database, then no time is spent with unnecessary downloading and changing, since there are no pertinent changes.

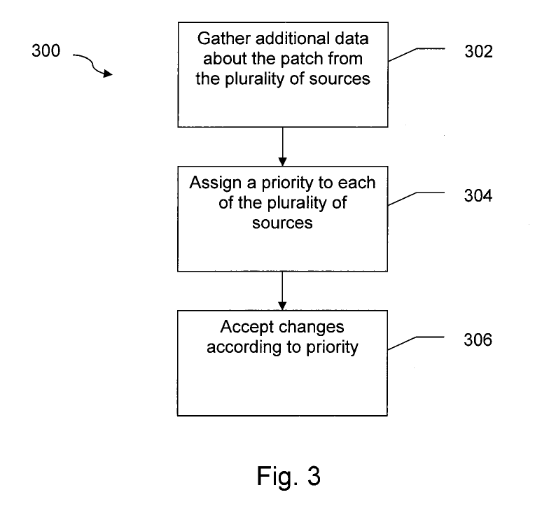

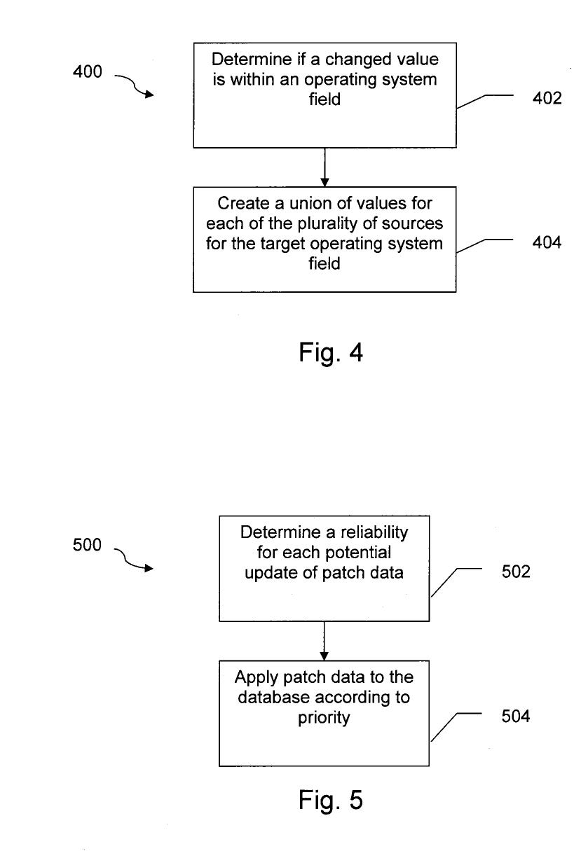

Prioritizing operates in various embodiments as shown in greater detail in FIG. 3. In one example, parsing 300 includes gathering additional data about the patch from the plurality of sources in block 302, assigning a priority to each of the plurality of sources in block 304, and accepting changes according to priority in block 306. Accepting changes may be done in a different way depending on the type of metadata that is being updated. For example, in an operating system update 400, shown in FIG. 4, accepting changes according to priority (block 306) is accomplished in one example by determining if a changed value is within an operating system field in block 402, creating a union of values from each of the plurality of sources for the operating system field in block 404, and accepting for other changes a change from a highest priority source of the plurality of sources when more than one of the plurality of sources has change information, as shown above in FIG. 3.

Assigning priority (block 304) is accomplished in one example, shown in FIG. 5, by determining a reliability for each potential update of patch data in block 502, and applying patch data to the database according to priority in block 504. There are two separate examples of resolving conflicts found when updating metadata. For a particular metadata value, taking a union of metadata or prioritizing metadata may be done depending on the type of the metadata.

Gathering additional data (block 302) is further aided in one example when data is gathered from at least one of a metadata file for the patch, additional files contained in the patch, and corrections and data supplements from other known sources. Sources can be many, and will necessarily vary depending upon the program that is to be updated. For example, for operating systems, the software provider often distributes a reference file identifying changes contained within a patch, the patch itself, files that are used by or may be prerequisites to the patch, and the like. In addition, there are additional sources of data that may be consulted, such as, but not limited to, correction data provided by third-party sources such as forums, internal testing within an organization, user or customer supplied data, and the like. Each component of information about a patch may appear in multiple sources. When a patch is downloaded, it is typically provided with an updated metadata file. At that time, analysis is performed in one example on the metadata file as well as the patch itself. Information that is obtained or known about the patch is amalgamated to produce an information store containing information known about a particular patch, including all information with prioritized data sources.

If two or more different sources indicate differences, that is, the information about the patch conflicts between two or more sources, and prioritizing is indicated by the type of the data, then the highest priority classified source is used to update the metadata. For many pieces of update data, the updated metadata uses the information from the highest priority source. The priority of a source is determined in one example through one or more of testing, prior knowledge, type of update, etc. For other types of patches, for example a prerequisite, a highest priority source is likely the best choice. If information in patches from a particular provider is known to be accurate, then the patch takes priority in one example. The priority is determined therefore by knowledge gained in the application of previous patches to the updated database. In some special cases, a union is the preferred choice for metadata in which all sources have equal priority. If a source of patch metadata with higher priority is found, that metadata is used over the union.

In some instances, a supplied metadata file will differ in its information from the patch itself. For example, if a patch A identifies that it depends on an earlier patch B, patch A typically has that encoded into the patch. However, if patch B is updated with patch B′, the metadata file for patch B′ may note that, and even the metadata file for patch A if distributed later may note that, but patch A itself is only coded that it depends on patch B, then the metadata file would have a higher priority. Still further, multiple sources of data may have different life cycles. For example, if a patch is released, after that it may later be marked as bad, obsolete, released, or the like. If the patch is known to be released, but a subsequent patch is indicated as obsolete by the metadata file, the newer source of information is likely to be most accurate. Priority depends upon the information itself, but in the various embodiments of the present updating process, older information is maintained in case it is needed later for any of the reasons shown.

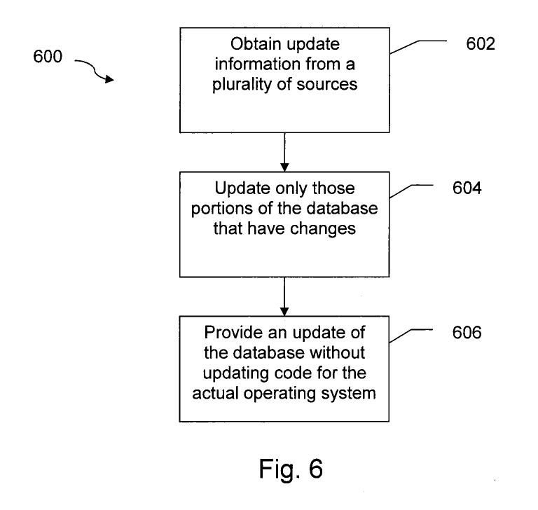

Supplementing operates in various embodiments as shown in greater detail in FIG. 6. In one example, supplementing 600 includes obtaining update information from a plurality of sources in block 602, updating only those portions of the database that have changes in block 604, and providing an update of the database without updating code for the actual operating system in block 606. In another example, supplementing patch data is performed using at least one of supplementing, correcting, adding to, combining, and modifying existing patch data.

In operation, installation of a patch is performed by attempting to install the patch given the patch itself. If the patch does not install correctly, then a determination is made as to how to effectively install the patch. If the patch is not installing correctly due to the metadata, then supplemental sources may be used to determine what part of the metadata is to be supplemented, and appropriate sources can be consulted. When updated, the supplemental metadata is deliverable to a customer to merge with the existing database without a rewrite of any code that is used in updating. Instead of recoding an entire software updating piece of software, a supplemental data file is provided, which in one example is merged into the customer's database. The embodiments therefore provide the ability to correct bad or incomplete metadata or to add new metadata without code changes. The data is changed, not the code to implement the modified data. This allows the provision of only the data that is relevant to the customer, that is, only that data pertaining to patches the customer has installed, without additional changes that may have been made in a patch but which are not desired by the customer. This provision of updated data also reduces the physical amount of material that is delivered to the customer, saving bandwidth and time. Instead of providing an entire new updating tool, the update file of the present examples provides information only on those changes that are to be made.

Supplemental data is kept at a level so as to make it manageable, without sacrificing quality. Since no new tool is provided, the amount of actual data that is presented with an update according to the embodiments of the present disclosure is significantly lower than for a solution that provides an entire new updating tool with hard-coded changes. It also allows the changes to multiple versions of a program if those changes are universally applicable, as opposed to using a hard-coded change for each version. With the number of versions of some software programs reaching well into double digits, such a hard-coded change update can be unwieldy.

The provision of supplemental data in a change-only environment also allows for updates to cover changes among multiple versions of a program. For example, since a change file is used as the basis for the updated database of the present disclosure, the supplemental data can be ordered according to a version-to-version change. Logical expressions allow for the updating of any version to any other version since the changes from version to version are all contained within the updated database. The corrections are self-contained within the logic of the correction database itself. Most update changes to software are based on one of a relatively small number (say 10-12) of types of corrections that are made. Such changes as those using missing prerequisites, incomplete operating system specifications, and the like are reduced by the nature of the update database generated in the various examples.

In many instances, updates to software are done using a brute force method that hard codes changes into an installer package, and the installation is hard coded for all parts of the patch. In contrast, the present examples provide updates without hard coding the patch. This allows for version control, that is, a patch can be provided from any version of a software to any other version using the update database file generated with the present examples. This flexibility allows the present examples to provide a file capable of patching a number of different revisions of software with one data update, instead of using multiple hard coded options. Still further, a particular update can be applied to any patch falling within a range of patches that all patch in the same way. For example, one update may be applicable to multiple revisions of a piece of software. A hard coded option hard codes the change for each different revision, whereas the present examples can code the change as applicable to each revision to which it applies, so there is less code used. Changes provided in the present examples are smaller and generally more targeted and are therefore easier to use and more directed to actual issues a customer has or wants to correct.

The present examples are not restricted to use with specific patches, since a hard coded change file is not what is provided to customers. Instead, what is provided is a file, in one example an extended markup language (XML) file containing supplemental data and in other examples only that subset of data used for specific patches that a customer desires. For example, the XML file in one embodiment may provide supplemental data (not code, just data) and only that subset of data relevant to a specific patch or set of patches, and contains in one example the patch name and the changes to be made.

In greater detail, the functions of the examples assess differences between an old and a new version of a source file. For entries that have changed, both old and new records are parsed into lists of key-value pairs. Each key-value pair indicates a location and a change for a change from the old and new versions of the source file. Each of the key-value pairs for the new records are processed using the existing data and the old data to determine what changes should be made to the database. Assigning priority uses data from the various sources with priority coded based on the field and the data's source. In some cases there is only one source for that data field, whereas for other fields there are multiple sources. In the case of multiple sources, the sources may have a priority ordering so that data values from the highest priority source with valid data are used to update a data record. In the case of equal priorities, the data is merged together.

When data is merged, processing that takes place includes taking the union of certain data values, updating certain data values according to priority, removing redundant values, merging forward, and sanitizing the results. Merging forward takes into account the lifecycle of the data. A data field may implement a life cycle for the particular data, for example, test, released, or obsolete. If multiple sources of a data field have different lifecycle values, the oldest or highest value is used. Supplementing data from available sources allows the updated database of patch data to be as accurate as possible, and in most cases, much more accurate than any single source of data. In updating a customer's software, the updated database is provided in one example as a supplement delivered as a collection of key-value pairs for each data record that has a change for a code portion the customer uses.

The supplement is made available to customers, and the customer apply the supplement to its installation. When the supplement is imported by the customer, all of the contained data record supplements are applied to the existing matching data records. Also, the supplemental data is added to the updated patch database so that it can be applied to subsequent data record modifications, whether they be for new records or existing records that are modified.

Various examples of the present disclosure may be embodied in a computer program product, which may include computer readable program code embodied thereon, the code executable to implement a method of maintaining a database of patch data. The computer readable program code may take the form of machine-readable instructions. These machine-readable instructions may be stored in a memory, such as a computer-usable medium, and may be in the form of software, firmware, hardware, or a combination thereof. The machine-readable instructions configure a computer to perform various methods of thread balancing and allocation, such as described herein in conjunction with various embodiments of the disclosure.

In a hardware solution, the computer-readable instructions are hard coded as part of a processor, e.g., an application-specific integrated circuit (ASIC) chip. In a machine-readable instruction solution, the instructions are stored for retrieval by the processor. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are machine-readable instruction solutions provided to the user on some form of removable computer-usable media, such as a compact disc read-only memory (CD-ROM) or digital video disc (DVD). Alternatively, such computer applications may be delivered electronically, such as via the Internet or the like.

It will be appreciated that embodiments of the present disclosure can be realized in the form of hardware, machine-readable instructions, or a combination of hardware and machine-readable instructions. Any such set of machine-readable instructions may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement embodiments of the present disclosure. Accordingly, embodiments provide a program comprising code for implementing a system or method and a machine readable storage storing such a program. Still further, embodiments of the present disclosure may be conveyed electronically via any medium such as a communication signal carried over a wired or wireless connection and embodiments suitably encompass the same.

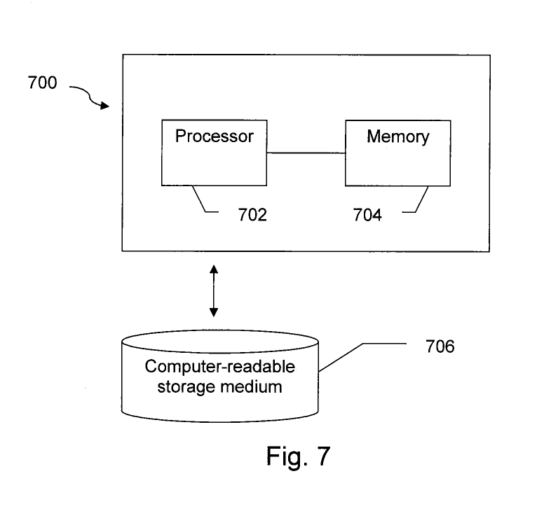

FIG. 7 is a representation of a computer system 700 for use with various embodiments of the disclosure. The computer system 700 includes a processor 702 connected to and capable of communication with a computer readable memory 704. Computer-readable storage medium 706 is in communication with system 700.

Computer-readable storage media in various embodiments may include different forms of memory or storage, including by way of example semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Further, the medium 706 may be located in any one of a number of locations, for example only, local to the system 700, or remotely located and accessible via a network such as a local area network (LAN), wide area network (WAN), storage area network (SAN), the internet, or the like.

Computer-readable storage media contains a computer program product having machine-readable instructions stored thereon adapted to cause the processor 702 to perform one or more methods described above with respect to FIGS. 1-6.

The embodiments of the present disclosure provide an update database related to a piece of software, such as an operating system, office suite, or the like, that contains information not only about current patches, but also about all patches released as of the update date for the update database. This includes information from the patches and associated patch files themselves, from the metadata files provided about the patch, and from secondary sources. The combined update database becomes more accurate than any single source of information. A customer can decide if and when the customer wishes to update, and can decide what patches and updates to install without being required to install each and every update. Database supplements are deliverable to a customer independent of hard coded updates, that is, a newly coded tool is not used for updates, but instead, a database containing information on the updates and how to install them is provided. The update therefore provides a customer with updates of data without new code, and potentially new bugs or issues with updates the customer does not want.

In various embodiments, the initial data is gathered from the metadata file released by a software provide. From this metadata file, information is gathered about what patches are currently available, what patches have been marked as recommended, security, bad, obsolete, and various other metadata. The information from the metadata file is parsed, and that parsed data, comprising change data, is stored in an update database. This may be done on a customer server, so that each customer builds its own database, which over time will contain data of just the patches the customer desires. The metadata file may be updated as often as once a day, or even more. The nature of the changes to metadata files of software providers typically consist primarily of removing metadata for patches that have become obsolete, adding metadata for patches that have been newly released, and updating metadata for patches that have already been released. The majority of the file remains unchanged from day to day. Therefore when the metadata file is parsed, a copy of the file is saved, and the next time the file is parsed, it is only parsed to the extent of differences between the new file and the file that was last parsed.

The customer can run a command to update its database with a new version of the metadata file at its convenience. Because the update database is cumulative, information about patches that have become obsolete is not lost, but is marked as obsolete. As long as the customer wishes to retain information on a patch, it remains in the customer's database. In one embodiment, the customer can download a patch using a command line tool. The command line tool will downloads the desired patch, parses additional metadata directly from the patch, and is supplements with secondary sources as determined through data merger and supplementing as described in greater detail above. Once the customer obtains the supplement, the metadata contained therein is automatically added to the customer's metadata database. This supplemental data is cumulative, and so at any given time the customer only needs to get the most recent version of the supplemental data, as it contains all the necessary supplemental data.

The features disclosed in this specification (including any accompanying claims, abstract and drawings), and/or the portions of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

Although specific embodiments have been illustrated and described herein, it is intended that the scope of the claimed subject matter be limited only by the following claims and equivalents thereof.

What is claimed is:

1. A method of maintaining a database of patch data for a system, comprising:
parsing differences between a posted update and a previously posted update;
prioritizing patch data from the posted update and a plurality of additional sources; and
supplementing patch data in the database for the posted update based on parsed differences and the plurality of additional sources.

2. The method of claim 1, wherein parsing further comprises:
comparing the posted update to the previously posted update;
identifying differences between the posted update and the previously posted update;
updating the database with information that has changed or been added in the posted update, and maintaining in the database information that has been deleted from the previously posted update to the posted update.

3. The method of claim 1, wherein supplementing patch data comprises at least one of supplementing, correcting, adding to, combining, and modifying existing patch data.

4. The method of claim 1, wherein prioritizing patch data further comprises:
gathering additional data about the patch from the plurality of sources;
assigning a priority level to each of the plurality of sources; and
accepting changes according to priority.

5. The method of claim 4, wherein accepting changes according to priority further comprises:
determining if a change is an operating system specific change;
creating a union of information from each of the plurality of sources for an operating system specific change; and
accepting for other changes a change from a highest priority source of the plurality of sources when more than one of the plurality of sources has change information.

6. The method of claim 4, wherein assigning a priority level further comprises:
determining a reliability for each potential update of patch data; and
applying patch data to the database according to priority.

7. The method of claim 6, wherein applying patch data to the database according to priority further comprises:
determining if a change is an operating system specific change;
creating a union of information from each of the plurality of sources for an operating system specific change; and
accepting for other changes a change from a highest priority source of the plurality of sources when more than one of the plurality of sources has change information.

8. The method of claim 4, wherein gathering comprises gathering from at least one of a metadata file for the patch, additional files contained in the patch, and corrections and data supplements from other known sources.

9. The method of claim 1, wherein supplementing further comprises:
obtaining update information from a plurality of sources;
updating only those portions of the database that have changes; and
providing an update of the database without updating code for the actual operating system.

10. The method of claim 1, and further comprising:
updating only those portions of the database that have changes; and
supplying a database update file containing only those portions of the database that have changes.

11. The method of claim 1, and further comprising:
providing changes to a plurality of revisions of the operating system via a single line in a patch database.

12. The method of claim 1, wherein supplementing patch data is performed for all operating system revisions regardless of patch data.

13. A computer program product, comprising a computer usable medium having a computer readable program code embodied therein, the computer readable program code adapted to implement a method for maintaining a database of patch data, the method comprising:
parsing differences between a posted update and a previously posted update;
prioritizing patch data from a plurality of sources; and
supplementing patch data based on observed and computed differences.

14. The computer program product of claim 13, wherein the computer readable program code is further adapted to parse differences by:
comparing the posted update to the previously posted update;
identifying differences between the posted update and the previously posted update;
updating the database with information that has changed or been added in the posted update, and maintaining in the database information that has been deleted from the previously posted update to the posted update.

15. The computer program product of claim 13, wherein the computer readable program code is further adapted to supplement patch data by at least one of supplementing, correcting, adding to, combining, and modifying existing patch data.

16. The computer program product of claim 13, wherein the computer readable program code is further adapted to prioritize patch data by:
gathering additional data about the patch from the plurality of sources;
assigning a priority level to each of the plurality of sources; and
accepting changes according to priority.

17. The computer program product of claim 13, wherein the computer readable program code is further adapted to supplement by:
obtaining update information from a plurality of sources;
updating only those portions of the database that have changes; and
providing an update of the database without updating code for the actual operating system.

18. The computer program product of claim 13, wherein the computer readable program code is further adapted to:
update only those portions of the database that have changes; and
supply a database update file containing only those portions of the database that have changes.

19. The computer program product of claim 13, wherein the computer readable program code is further adapted to provide changes to a plurality of revisions of the operating system via a single line in a patch database.

20. The computer program product of claim 13, wherein the computer readable program code is further adapted to supplement patch data for all operating system revisions regardless of patch data.
